(19) United States
(12) Patent Application Publication
(10) Pub. No.: US 2007/0085012 A1
(43) Pub. Date: Apr. 19, 2007

(54) Apparatus and method for the spatial resolution of a pet scanner used for molecular imaging

(75) Inventor: Christopher J. Thompson, Montreal (CA)

Correspondence Address: Ansel M. Schwartz;Attorney at Law, Suite 304, 201 N. Craig Street, Pittsburgh, PA, 15213, US

(73) Assignee: McGill University

(21) Appl. No.: 11/581,123

(22) Filed: Oct. 13, 2006

Related U.S. Application Data
(60) Provisional application No. 60/728,570, filed on Oct. 19, 2005.

(51) Int. Cl. G01T 1/166

(52) U.S. Cl. 250/363.05

(57) ABSTRACT

A PET scanner for an object includes a plurality of detectors. The scanner includes a support for the object which moves continuously in a predetermined way. The detectors disposed about the support. A method for scanning an object includes the steps of moving a support with the object continuously in a predetermined way. There is the step of obtaining data from the object with detectors disposed about the support as the support is moving continuously. A PET scanner for an object includes a mechanism for obtaining data from the object. The scanner includes a mechanism for supporting the object which moves continuously in a predetermined way. The obtaining a mechanism disposed about the support a mechanism.

### FIELD OF THE INVENTION

This invention relates to a medical imaging field known as positron emission tomography (PET) and specifically to the use of that imaging technique for the study of the distribution of compounds which have been labeled with positron emitting isotopes preferably in small laboratory animals or biological samples. In a PET scanner, detectors are sensitive to the gamma-ray photon pairs which arise due to positron annihilation, and are normally scintillation crystals which record events that result when each photon of the pair collides with a crystal.

### BACKGROUND OF THE INVENTION

Typically, tomographic methods such as single photon emission computed tomography (SPECT) and positron emission tomography (PET) rely on measurements of poor quality due to broad spatial response functions imposed by properties of the particular system. In general, tomographic systems are used to infer a spatial distribution or estimate of a spatial distribution of a selected property of an object within the object's interior as determined from measurements of emanations from or through the object. For example, gamma rays emanate from an object in PET systems. Tomographic measuring mechanisms typically use an external source and detector as in the case of X-ray computed tomography (CT), or internal induced emanations and external detectors as in the case of PET or SPECT.

Often times, these spatial distributions are represented in picture form for visual analysis. Therefore, these spatial distributions are commonly referred to as images although they need not necessarily be pictorially represented (e.g., the values at various points may be analyzed by computer to determine biological parameters or other object properties).

When a pictorial representation is displayed, the effect of broad spatial response functions manifests as a visual blurring. When, instead, the spatial distribution of interest is used to form estimates of some biological parameter, the effect causes a kind of numerical inaccuracy known as a partial volume effect.

PET as a biomedical imaging modality, is unique in its ability to provide quantitative information regarding biological function in a living subject. PET is a technique in which the distribution of a radioactive tracer material, introduced into an object, is reconstructed from the distribution of detected gamma-ray pairs that are emitted from within the object as a result of decay. PET is a powerful tool for brain research since, through proper selection of tracer materials, it provides non-invasive measurements of brain function through variables such as metabolism and blood flow. PET is also effective in assessing perfusion and tissue viability and, therefore, is widely used in cardiology and oncology.

Unfortunately, its use has been hampered by the poor spatial resolution of the images produced, resulting primarily from the relatively large detectors used to acquire the tomographic measurements. The poor image quality obtained by PET results from a number of factors, the most serious of which are blur due to broad spatial response functions and quantum noise due to detector response characteristics and limitations on permissible radiation dose.

This is especially true when PET is used for imaging of small laboratory animals which are commonly used, for example, to investigate new drugs which may eventually be used by patients suffering from a particular disease, in order to assess the efficacity of these new drugs. The small organs in laboratory mice or rats present a great challenge to the spatial resolution of the best PET scanners.

In PET, each radioactive decay event, taking place within the object, leads to the simultaneous emission of two gamma rays in nearly opposite directions. These gamma rays are then counted by a detector system typically including one or more circular rings comprising a plurality of adjacent detectors positioned about the object. The detectors are connected to electronic coincidence circuitry.

An event is assumed to have taken place when two detectors register gamma rays at approximately the same instant of time. Since it is known that the gamma rays travel at 180 degree angles from one another, simultaneous detection serves to provide information regarding the location of the parent event.

Generally, if the spatial response functions limit system spatial resolution, then the sampling rate afforded by the fixed positions of the detectors is typically insufficient to adequately characterize a signal out to the spatial frequency bandwidth determined by the spatial response functions. One solution, commonly employed in PET, moves the detection system to various positions to enable additional samples to be obtained. Using conventional methods, these extra samples in principle allow the signal to be specified accurately up to the bandwidth associated with the detector response functions, but detector response remains the limit on achievable resolution.

In common PET scanners designed for imaging human subjects, many detectors are arranged in a series of rings which surround the region of the patient's body being scanned. Before a PET scan is performed, the patient is injected with a radio-pharmaceutical, such as fluoro-deoxyglucose (FDG) . The radio-pharmaceutical is labeled with fluorine-18 which emits positrons that interact with electrons in the body. As a result of the interaction, the positrons are annihilated and pair of gamma rays result. Photon pairs leave the point of the interaction in directions of travel that are 180° apart from each other. When a photon comes in contact with a crystal of a detector, a scintillation event occurs. The scintillation event is detected by the photo detector device of the detector creating analog information. The analog information is digitized and processed by electronics and software to produce image information about objects such as tumors in the body. Typical PET scanners include detectors with multiple devices such as photo-multipliers.

The spatial resolution of PET scanners is ultimately limited by the basic underlying physics of positron decay and detection of the two annihilation photons which result when a positron and electron combine to form positronium and subsequently produce two 511 keV gamma rays which are detected by the scanner's detectors. However, the main limitation is still the cost of manufacturing small crystals which places a practical limit as opposed to a fundamental limit on the spatial resolution.

Referring to FIG. 1, when in a conventional PET system there occurs a simultaneous detection of two gamma rays by two detectors at different points in the ring, a decay event is assumed to have taken place somewhere along a line connecting the centers of the two detectors 1 and 2. The mathematical foundation for traditional tomographic reconstruction techniques assumes the available measurements to consist of integrals of some object property along idealized rays of infinitesimal width, known as projection lines. However, the response of a pair of detectors is not confined to a line joining their centers, but has a distribution illustrated in shades of gray as shown in FIG. 1. In the conventional method for reconstructing PET images, the lines connecting the centers of the detectors take the place of these idealized projection lines. This is a very poor approximation which contributes to the low quality of conventional PET images. In reality, because actual detectors have finite extent, the simultaneous detection of two gamma rays proves that a decay event has taken place, not along an idealized ray, but within a broad region defined by the corresponding spatial response function as illustrated in FIG. 1.

Motion has been incorporated in many PET systems to improve sampling. One type of motion is commonly known as wobble. Wobble refers to an in-plane orbital motion of the entire detection array (not rotation of the entire detector array) in the prior PET literature. The first use of the motion of the detector array to improve the sampling was in the PETT VI scanner in 1982 [Yamamoto M, Ficke D, ter-Pogossian M M: “Performance Study of PETT VI, A Positron Computed Tomograph with 288 Cesium Iodide Detectors” IEEE Trans. Nucl. Sci. NS-29 529-533 (1982), incorporated by reference herein]. In that instrument, the events were assigned on the basis of the actual angle of the wobble motion at the time the event was detected.

A substantial improvement was introduced in 1985. [Dagher A, Thompson C J: “Real time data re-binning in PET to obtain uniformly sampled projections” IEEE Trans. Nucl. Sci. 32 pp 811-817 (1985), incorporated by reference herein]. In this implementation, the data was re-binned into uniformly spaced bins along each projection. This technique was later incorporated into most commercial PET scanners in which the wobble motion of the detectors was employed to improve the sampling. A simple analogy of this process could be obtained by releasing sand into a series of equally spaced buckets from a children's playground swing. If the sand is released at a constant rate, the buckets at the end of the swing's traverse will fill faster than the central ones since the swing is traveling faster near the center. This non-uniform filling must be compensated for before the image is reconstructed, but the width of the samples is constant, so no interpolation is required prior to reconstruction is required.

In the past, the detection system traveled in a continuous motion, and gamma rays are counted (measured) throughout. In the early PET scanners (e.g. PETT VI) the gamma rays were counted during time intervals of equal duration are grouped together and are considered as single observations constituting additional samples of the signal along the direction of the projection profile. In more modern implementations the data is binned by projecting the detector's angular deviation onto the projection into which it will be saved. The gamma rays detected during a single time interval are usually treated as having been observed, not over a range of positions as is actually the case, but at a single point within that range. It is possible to stop the motion at discrete positions to achieve precisely what is approximated by the continuous motion; however, for practical reasons of mechanical design, continuous motion is more commonly employed.

In the 1980 and 90 decades, PET scanners for. human imaging employed 1:1 coupling of the crystal which detects the gamma ray and a photo-multiplier which converts the light from the scintillation crystal into an electrical pulse. This was very expensive, and provided inadequate spatial sampling. In those days, several scanners employed an eccentric motion of the detectors, commonly known as “wobbling”, whereby the entire detector array was mounted on eccentric bearings and moved on the circumference of a circle whose diameter was of the order of the crystal size, (in those days 10-20 mm).

This form of motion was abandoned by scanner manufacturers with the introduction of “block detectors” [U.S. Pat. No. 4,743,64 Casey, Nutt, Douglass “Two dimensional photon counting position encoder system and process”, 1988, incorporated by reference herein]. Only a few scanners employed both block detectors and wobble motion, including the Scanditronix PB2048B which was sold in the 1980's by Scanditronix AB, (Uppsala, Sweden), one of which was used for many years at the Montreal Neurological Institute. [Evans A C, Thompson C J, Marrett S, Meyer E, Mazza M, Holte S, Weltman R, Ericson T: “Performance evaluation of the PC2048, a new 15-slice encoded-crystal PET scanner for neurological studies” IEEE Trans Med Imag. 10:1 pp 90-98 (1991), incorporated by reference herein.]

Recently, the reasons why PET scanners with block detectors have poorer spatial resolution that those with 1:1 coupling between the crystals of comparable size with light sensors have been investigated. “Block detectors” is the term commonly used in the PET instrumentation literature to describe a gamma ray detector consisting of a relatively large crystal of scintillator which is cut into a number of smaller elements and which is coupled to a small number of light sensors which are then read out simultaneously and have their signals processed in a manner which allows the identification of each crystal. This research has demonstrated that at least some of the blurring associated with these detectors is not intrinsic to the detectors, but rather is due to undersampling of the image space with fixed detectors which results in aliasing in the projections used to form the images, and therefore to a blurring of the images. This work has been presented and published in peer-reviewed papers. [Thompson C J, St. James S, Tomic N: “Under-sampling in PET scanners as a source of image blurring” Nucl. Inst. and Meth. (A) 545:2 436-445 (2005), Tomic N, and Thompson C J: “Investigation of the ’block effect' on spatial resolution in PET detectors” IEEE Trans. Nucl. Sci. 52:3 599-605 (2005), both of which are incorporated by reference herein].

### BRIEF SUMMARY OF THE INVENTION

The present invention pertains to a PET scanner for an object. The scanner comprises a plurality of detectors. The scanner comprises a support for the object which moves continuously in a predetermined way. The detectors disposed about the support.

The present invention pertains to a method for scanning an object. The method comprises the steps of moving a support with the object continuously in a predetermined way. There is the step of obtaining data from the object with detectors disposed about the support as the support is moving continuously.

The present invention pertains to a PET scanner for an object. The scanner comprises means for obtaining data from the object. The scanner comprises means for supporting the object which moves continuously in a predetermined way. The obtaining means disposed about the support means.

A method and system for improving signal recovery for tomographic-type detection systems is disclosed which reduces the effect of blurring caused by the intrinsic under-sampling of the detectors' view of the object space by moving the object being imaged in a continuous eccentric motion during the time the image is acquired such that multiple tomographic measurements are taken of substantially the same signal when the object and detection means are at different relative positions. The measurements are then represented as a finely and uniformly sampled set of projection profiles without the requirement of interpolation of the samples onto a uniform grid. The tomographic signal elements may then be used as data in projection profiles to generate projection matrices or images directly using conventional image reconstruction techniques.

The present invention pertains to a PET scanner for imaging small animals, or biological samples. The scanner comprises stationery, circular arrays of gamma-ray sensitive detectors, forming a cylindrical detector, into which the object to be scanned is placed on a support which executes an eccentric movement during the scan, such that the radius of the movement is of the order of the detector width.

### BRIEF DESCRIPTION OF THE SEVERAL VIEWS OF THE DRAWINGS

FIGS. 1a and 1b show the correspondence between the detectors on the ring of a PET scanner (FIG. 1a) and the encoding of detected events into a sinogram (FIG. 1b).

FIG. 2 shows sets of coincidence response functions in shades of gray of detector-pairs.

FIGS. 3a, 3b, 3c and 3d show a top view, front view and side view of the PET scanner of the present invention, and a disk, respectively.

FIG. 4 shows the disposition of the detector array within which the animal-support bed is mounted on eccentric bearings to enable the wobble motion during the scan.

FIG. 5 is an illustration of the mechanism which enables the bed's wobble motion in the preferred embodiment.

FIG. 6 shows the geometry of wobble movement during a scan.

FIG. 7 is an illustration of the measurement of the wobble displacement.

FIG. 8 shows the division of the cycle into uniformly spaced bins performed by projecting the circular motion onto a line.

FIG. 9 shows the response as a function of spatial frequency.

FIG. 10 is a front view of the scanner.

FIG. 11 is a side view of the scanner.

FIG. 12 is a side view showing the motor, eccentric bearings and bed support plate to which the bed is attached.

### DETAILED DESCRIPTION OF THE INVENTION

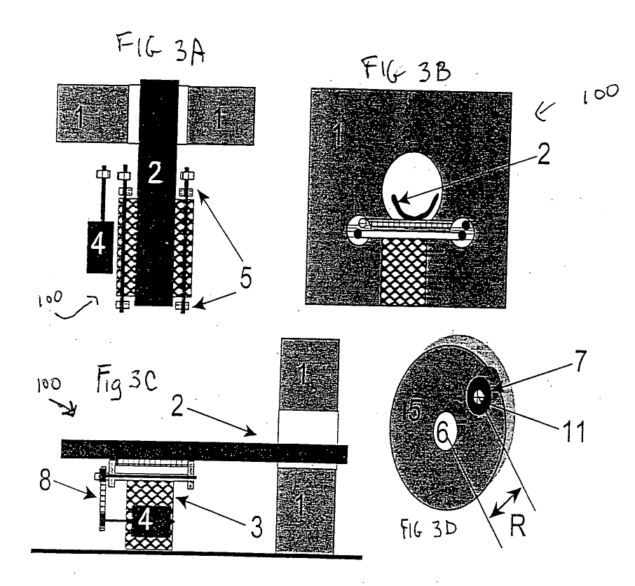

Referring now to the drawings wherein like reference numerals refer to similar or identical parts throughout the several views, and more specifically to FIGS. 3 and 6 thereof, there is shown a PET scanner 100 for imaging small animals, or biological samples. The scanner 100 comprises stationery, circular arrays of gamma-ray sensitive detectors, forming a cylindrical detector, into which the object to be scanned is placed on a support which executes an eccentric movement during the scan, such that the radius of the movement is of the order of the detector width.

Preferably, a record of the addresses of each pair of crystals which detects simultaneous gamma rays during the scan is saved in the event-by-event list into which timestamps and reports of the position of the moving support are introduced at appropriate times during the scan. The location of the support at the time of each detection of each pair of simultaneous gamma rays is preferably determined by interpolation between the respective timestamps and support position reports. Preferably, the position information may be used to increase a spatial sampling frequency of the moving object by incorporating its position, at the time of each detection into a mathematical algorithm used to reconstruct the image of the object from the recorded events. Higher spatial frequencies are preferably extracted from the detected events than would be possible if the object remained stationary during the scan.

The present invention pertains to a PET scanner 100 for an object. The scanner 100 comprises a plurality of stationary detectors. The scanner 100 comprises a support for the object which moves continuously in a predetermined way while the detectors obtain data from the object, the detectors disposed about the support.

Preferably, the scanner 100 includes a signal processor connected to the detectors. The detectors are preferably part of a gantry 1 which receives the support. Preferably, the support includes a bed 2 upon which the object is placed. The support preferably includes a stand 3 for the bed 2. Preferably, the support includes eccentric bearings 5 through which the bit is coupled to the stand 3. The support preferably includes a motor 4 which moves the bed 2.

Preferably, the support includes a shaft 21 with disks 15 attached to the shaft, the motor 4 drives the shaft. The support preferably includes a toothed belt 8 connected to the motor 4 and the shaft 21 through which the motor 4 drives the shaft. Preferably, the structure includes an axle 12 attached to the disks 15 and the bed 2. The axle 12 is preferably offset from the shaft by a distance R, which defines a wobble circle radius that the bed 2 is constrained to move in by the motor 4. Preferably, the detectors obtain data in list mode.

The present invention pertains to a method for scanning an object. The method comprises the steps of moving a support with the object continuously in a predetermined way. There is the step of obtaining data from the object with stationary detectors disposed about the support as the support is moved continuously.

Preferably, the moving step includes the step of moving the support with the object in an eccentric movement during the scan, such that the radius of the movement is of the order of the detector width.

Preferably, there is the step of processing the data.

The present invention pertains to a PET scanner for an object. The scanner comprises means for obtaining data from the object. The scanner comprises means for supporting the object which moves continuously in a predetermined way. The obtaining means disposed about the support means.

Preferably, the obtaining means includes means for processing the data.

The supporting means includes the components shown in FIG. 3. The obtaining means includes stationary PET scanner detectors and the processing means includes a computer having PET scanner algorithms modified for the detectors being stationary and the support moving.

The technique described in this invention is to apply an eccentric motion (wobbling) to the “bed” used to support the small animal or sample during PET imaging, as opposed to moving the detectors as was previously done with human PET scanners. The advantage here is that the motion required is very small compared with that required in older human scanners (˜2 mm compared with ˜20 mm used previously) . The animal or sample and bed are much lighter than the detectors (200 gm compared with 100 kg for the detector array, so a small low powered motor can be used. The scanners on which one could to implement this technique collect data in “list-mode” rather than “histogram-mode”, so no major changes are required in the on-line data processing. “List-mode” refers to the way the events are stored during a scan. Here the addresses of the detectors (the detector number around the ring, and the ring number of each detector of the pair) are saved in a list during the scan and the elements in this list is saved to a mass storage medium during the scan. Periodically during the scan, time-stamps are interspersed with the detected events. It is common to allow for other information to be inserted into the list as well, and these other events are inserted as coded tag words. These scanners already include two inputs for synchronization of the data and time stamps in the data stream, so that the position of the bed need only be encoded once per revolution of the wobble mechanism.

The traditional approach to processing raw tomographic measurements from such a system is to assign the counts observed during the motion to a plurality of equally spaced points along an axis of a projection profile by traditional interpolation methods such as bilinear interpolation. In tomographic imaging applications, this step, known as rebinning, yields a projection matrix (or sinogram). After rebinning, corrections are made to the projection matrix to compensate for such factors as attenuation and scattering of gamma rays through tissue in the brain, and/or system variations such as variation in detector sensitivity and other necessary corrections.

The corrected projection matrix is then used to reconstruct the image using various techniques known in the art. The rebinning step is complicated by the fact that the measurements (samples) are distributed in a highly non-uniform way due to the ring geometry of the data-acquisition system and the nature of the wobble motion.

A blurring problem occurs using this approach since regardless of the number of samples obtained by the moving detection system, the spatial resolution of the signal cannot be improved beyond the limit imposed by the spatial response functions. Such conventional processing techniques used in the practice of PET and other tomography systems typically fail to take into account the broad spatial response functions that degrade the signal. Instead, conventional processing techniques assume idealized projection lines and assume infinitesimal detector elements.

Non-moving tomographic systems are known that have improved imaging over conventional moving systems but typically must use a large number of smaller and more expensive detectors to acquire an image. Such non-moving systems that use interpolation methods generally suffer from the same effects of blurring as do conventional moving systems. Also, improving existing moving systems by incorporating the smaller detectors is generally cost prohibitive given the high cost of smaller detectors and the cost of modifying existing hardware. There exists a need for a signal recovery method that improves signals and is compatible with designs for moving systems that use less expensive, larger detectors to help eliminate the need for higher cost detectors while improving the quality of the tomographic images.

Therefore, there exists a need for a method of reducing the effect of blur due to spatial response function in tomographic detection systems. Furthermore, there exists a need for a method of recovering signals in tomographic systems that takes into account effects of spatial response functions rather than assuming idealized conditions. A need also exists for an improved signal recovery method which substantially reduces the computational time for recovering tomographic signals.

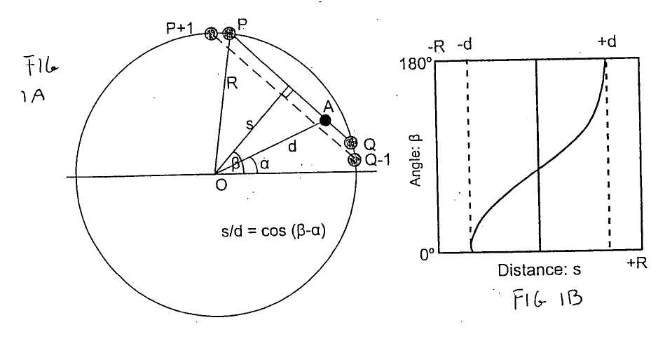

FIG. 1 shows how the detection of two simultaneous gamma rays in a PET scanner is encoded into a form suitable for reconstruction. Consider a point source of a positron emitting isotope, A. At some time, one of the pairs of gamma-rays is detected by two detectors P and Q on a circle of radius R, and whose origin is O, such that the points P, A and Q are co-linear. The distance from the point A to the center of the circle is d, and the normal to the chord PQ on which the detectors lie which passes through the center of the circle has a length s. If there is only point source, then all the lines of response pass through the point A, but the detectors which detect them P, Q can be on any chord which passes through A, since their orientation is random. If the angle β, the normal to chord joining the two detectors, is plotted against the distance between the chord the center of the circle, then: s/d=cos(β−α) so that all the possible chords through the point A are represented by the curved path on the right side of FIG. 1. This is commonly known as a “sinogram”. Horizontal rows in this figure are the projections obtained from all the pairs of detectors which face each other on chords which are parallel. It is clear that since there are a finite number of detectors, the projections are sampled rather than being continuous functions. If one sample on a given projection is the chord P,Q, then the adjacent sample nearer to the center is (P+1), (Q−1), and the adjacent sample further from the detector is (P−1),(Q+1).

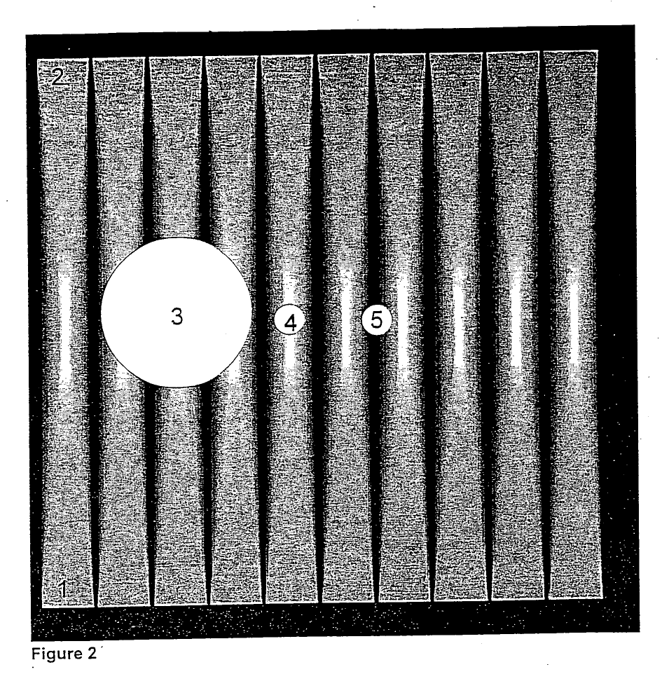

FIG. 2 demonstrates the inherent undersampling in conventional PET detectors. The vertical bands represent the sets of coincidence response functions of detector-pairs like 1 and 2, which face each other vertically and together estimate one projection of the objects in the center of FIG. 2. The circular object 3 is viewed in three such sets of detector pairs, but of the smaller objects, 4 is seen by only one set, and 5 is not seen at all.

FIGS. 3a, 3b and 3c show top, front and side views of PET scanner gantry 1 showing addition of a bed wobble mechanism. The bed 2 is supported by a stand 3 to which it is coupled through a set of eccentric bearings 5. A small motor 4 drives a shaft with shaded disks 15 attached. The shaft 21 goes through the center 6 of the disks 15 and the disks 15 have an additional hole 7 through which and axle attached to the moving bed support is attached. The motor drives the shaft 21 through a toothed belt 8. FIG. 3d shows a disk 15.

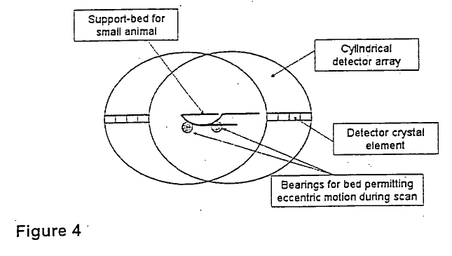

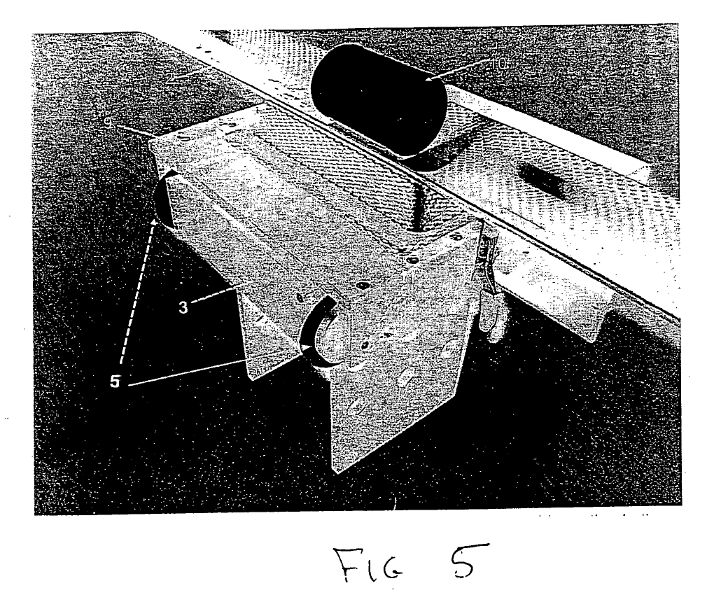

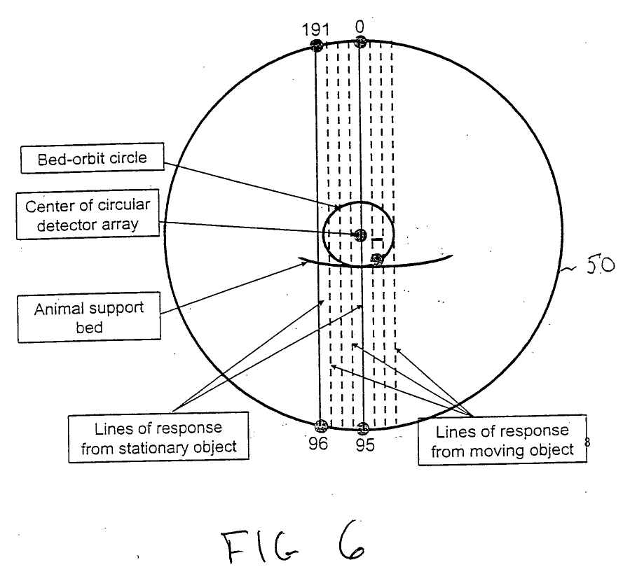

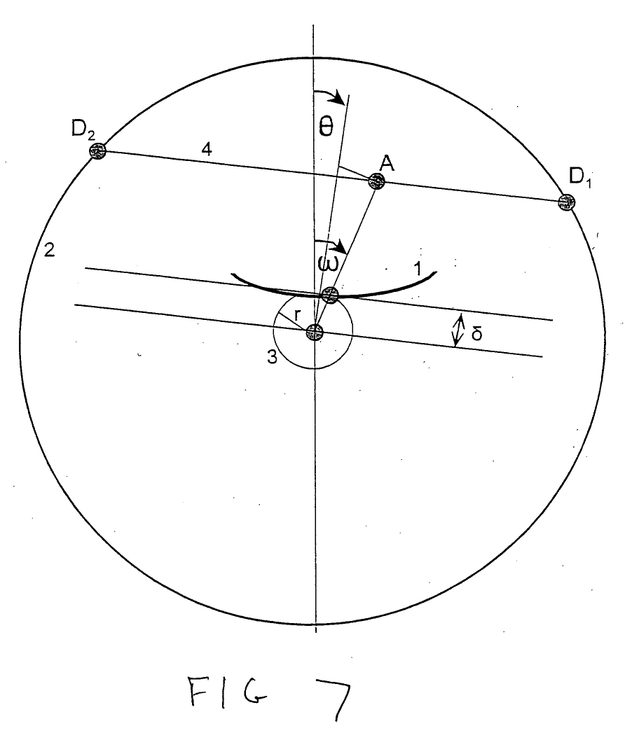

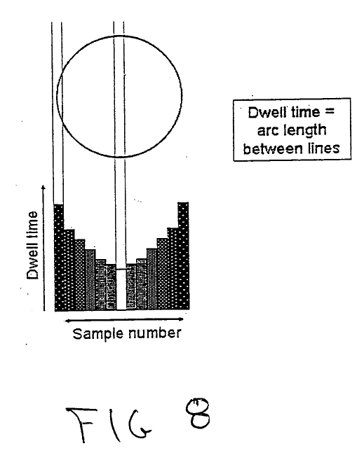

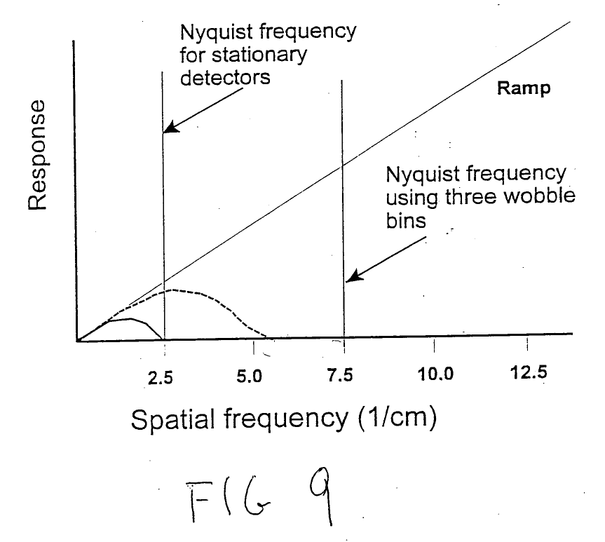

FIG. 4 shows the disposition of the detector array within which the animal-support bed is mounted on eccentric bearings to enable the wobble motion during the scan.

FIG. 5 is an illustration of the mechanism which enables the bed's wobble motion in the preferred embodiment. The bed 2 is attached to the bed support plate 9 which is coupled to the support stand 3 through eccentric bearings 5. The object 10 to be scanned shown as a cylinder here, is placed on the bed 2. To be scanned, it would be moved near the end of the bed 2 and into the scanner's field of view.

FIG. 6 shows the geometry of wobble movement during a scan. The large circle 50 represents the detector array with the locations of some detectors represented as small circles connected with solid vertical lines. The bed, while remaining horizontal, moves such that its center follows the path indicated by the small circle. The dashed lines represent additional samples of the projection (between the samples represented by the solid lines) which can be acquired as the bed moves through its path.

FIG. 7 is an illustration of bed-wobble geometry. D1 and D2 are two detectors whose locations define a line of response through the field of view. The angle θ is the normal to the line of response as measured from the vertical in the clockwise direction. The angle ω is the wobble angle, measured clockwise from the vertical. The displacement, δ, normal to the line of response due to this wobble angle is r·cos(ω−θ), where r is the radius of the wobble circle.

FIG. 8 shows the division of the cycle into uniformly spaced bins performed by projecting the circular motion onto a line. The dwell time in each bin is proportional to the arc length projected into each bin.

FIG. 9 shows the additional frequencies which can be used during the image reconstruction process when additional samples are available.

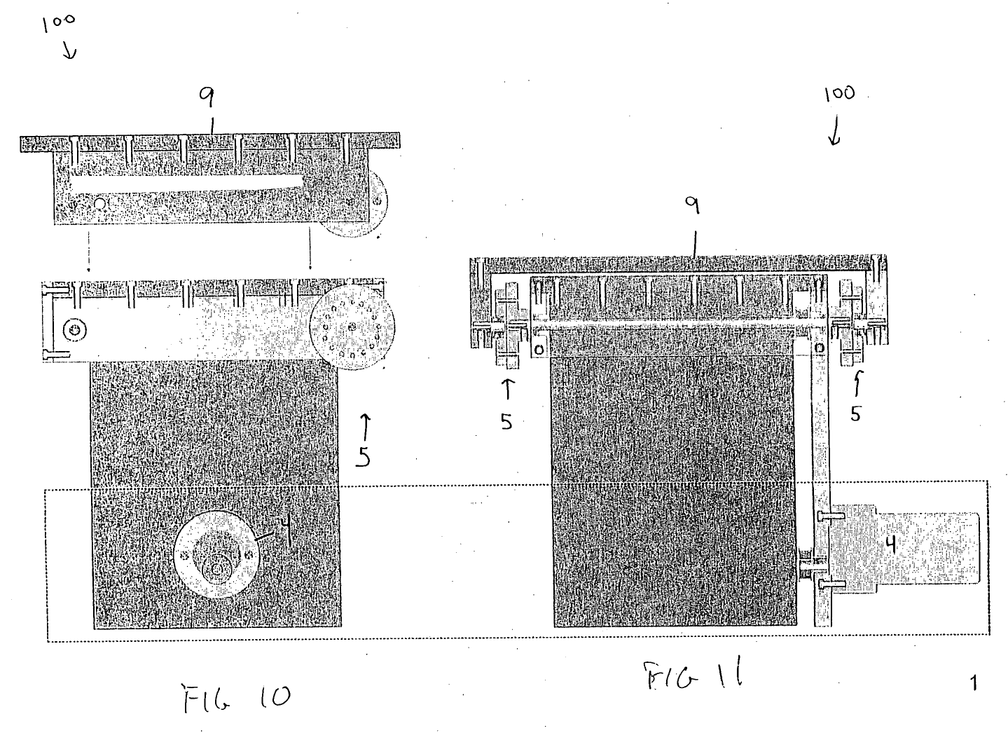

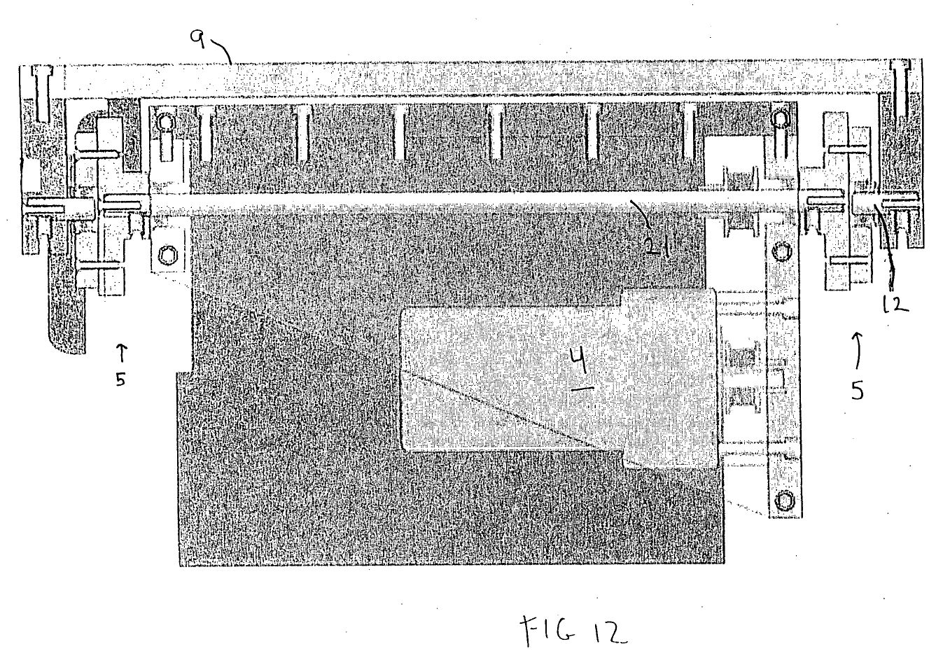

FIGS. 10 and 11 are front and side views of the scanner 100. FIG. 12 is a side view showing the motor 4, eccentric bearings 5 and bed support plate 9 to which the bed is attached.

Improved spatial resolution in a realistic time on a modern computer has been substantially met by the method and system of signal recovery for tomographic detection systems disclosed below. The inventive method recovers additional signal data by obtaining a finer sampling of the object during the scan than is possible with no movement between the object and the detectors. In the following, reference will be made to the drawings which show how the invention is implemented in the preferred embodiment. It will be realized that alternative means exist and this is meant to convey the principles of the invention but not to restrict its scope to the parts described herein. The purpose of the invention is to overcome the undersampling inherent in PET scanners due the extent of the detector-pair response function illustrated in FIG. 2. While a large object 3 is within the response functions of three sets of detector pairs, smaller objects like 4, and 5 may or may not be constrained to within the response function of any sets of detector pairs. FIG. 2 shows one projection of the image space derived from the response functions of those detector pairs through which vertical lines in the image space may be drawn. However, the response functions of all detector pairs at all angles through the image space are required to reconstruct an image from its projections. Thus it is likely that an object such as 4 while being well imaged in this example may not be when the projection at (for example only) 45 degrees to the one shown is measured or illustrated. The reverse is true for the object 5 which is not well imaged in FIG. 5, but which may be well imaged at other angles. In order for image reconstruction to be successful and free of artefacts, the projections from all angles must be consistent.

FIGS. 3, 4 and 5 show views of the implementation of this invention on a MicroPET R4 small animal PET scanner made by Concorde Micro-Systems of Knoxville Tenn., a subsidiary of Siemens Medical Solutions. The gantry, and animal support bed (and all other parts not illustrated) are the original parts supplied by the vendor. For the purposes of implementing this invention, a moving support has been added between the original bed support 3 and the scanner bed 2. These parts are held together, in a fixed configuration, in the un-modified scanner. The important parts of this are best illustrated in FIG. 3. The top plate of the original bed support was re-built and extended so that two axles lie parallel to and lower than either side of the bed. Toothed sprocket wheels attached to these shafts are driven by a motor 4 via a timing belt 8. At each end of the shafts, a disk 5 is attached such the shaft passes through a central hole 6 in the disk 5. An axle is attached to each of the disks illustrated as 5, but is offset from its center by a distance R. The center 7 has a bearing and a short axle to which the new bed support is attached with a screw 11 through its center. The offset distance, R, becomes the radius of the wobble circle on which all parts of the bed support, bed and its contents are constrained to move when the motor turns.

FIG. 6 illustrates the part of the sampling of the image space viewed on the horizontal projection. The scanner being described has 192 crystals disposed on the circumference of a circle. The crystal detectors are represented here by the numbers 0, 95, 96 and 191. The solid vertical lines represent the position of the detectors with respect to the bed when is in its original position location. When the bed moves in its orbit, the view of the detectors changes from the line joining 0 and 95 to that represented by one or another of the sets of dashed lines. One could think of the solid lines as the major markings on a ruler graduated in, say centimeters. The dashed lines represent a finer division of the major graduations, and could be, say, millimeters if there were ten of them.

FIG. 7 illustrates the trigonometric relationship between the angles and displacement of the object along the line of response joining a pair of detectors. Here, the object being scanned is placed on the moving bed 1 which is constrained to wobble on a circle 3 of radius, r. There N detectors are on the circumference of a circle 2, and a pair of simultaneous gamma rays resulting from a positron annihilation at point A are detected by D₁ and D₂. The normal to the line 4 joining D₁ and D₂ makes an angle θ with the vertical, (the origin of the detector array). The angle θ is related to the detector numbers by:
θ=2π(D₁+D₂)/2N 1

At the time this event is detected, the bed has moved along the wobble circle through an angle ω. The displacement along the projection, δ, due to the wobble angle is given by:
δ=r·cos(ω−θ) 2

It is this displacement which must be added to the distance, L, along the projection which is calculated from the detector numbers D₁ and D₂ as the length of the normal (5) to the line of response so that for detectors on a circle of radius R:
L=R·cos(2π(D₂−D₂)/2N) 3

Thus the actual location along the projection L′ is given by:
L′=L+δ 4

FIG. 8 shows the division of the wobble cycle into 13 equally spaced bins along a line below the circle. The pairs of vertical lines represent the boundaries of one bin. The graph below the circle shows the length of the arc (in the circle above them) which is contained within each bin. If this were left uncorrected, the reconstructed image would have a series of concentric rings. In previous PET scanners employing wobbled detectors, the elimination of these rings was performed by acquiring an image of a cylinder and calculating a compensation matrix based on the distortion of the image. In the present context, a novel method for eliminating the rings has been applied. It makes use of the fact that events are acquired in list-mode, and can be processed one by one during the formation of the sinogram which is used to reconstruct the image. During the binning, the difference, δ, is known from equation 2, and this can reference a unique bin, for which a normalization factor for the bin can be found. Thus, instead of incrementing the sinogram element (by 1) a value which is higher for the central bins and lower than one for the outer bins is added instead.

FIG. 9 shows the filter which must be applied to the projections in order to perform the image reconstruction. It is well known from the literature on image reconstruction, that a Ramp filter is required to correct the projections during reconstructions (see for example: Peters T M and Williams J C, Editors. “The Fourier Transform in Biomedical Engineering.” Birkhauser, 1998, or Bendriem B, and Townsend D W, Editors. “The Theory and Practise of 3D PET”, Kluwer Academic Press 1998, incorporated by reference herein.) However, the ramp filter must be rolled off with an apodizing function such that the output is zero at the Nyquist frequency. Since the image space was shown to be under-sampled, there are frequencies beyond the Nyquist frequency which are present in the detector response but would be aliased since they are above the Nyquist frequency. The apodizing filter (such as a Hanning filter) is multiplied by the ramp filter to ensure this does not occur. When additional samples are provided by wobbling the bed, the cut-off frequency can be increased from that shown as a solid curve in FIG. 8 to that shown in the dashed curve.

The present invention provides improved spatial resolution at a cost which would be a small fraction of that required to achieve that same improvement by making the crystals smaller. There is also a substantial time saving during image reconstruction. The above assumes that one can use the filtered-back-projection reconstruction algorithm to reconstruct the finely sampled data. If three times more bins are used to reconstruct the image, the image reconstruction time is about twice as long. On the MicroPET R4 scanner, these times are 2 and 5 seconds, respectively. There exist better reconstruction algorithms in the sense that they provide better image quality but at the expense of increased computation time. When the same image is processed by the iterative algorithm OSEM, the reconstruction time is several minutes, while if the MAP algorithm is used (which provides spatial resolution recovery by using knowledge of system matrix, the reconstruction time is about 45 minutes. Thus, the present invention provides comparable spatial resolution and noise to one which takes over 500 times longer to reconstruct on the same computer.

The main application at this time of this is in a fast growing imaging sector known as “Molecular Imaging” of small animals. This is proving to be very valuable to pharmaceutical companies and is seen as a way to demonstrate the utility of new drugs and reduce the cost of bringing potential new drugs to market. Many studies are done on small animals, and mice are very attractive due to the availability of genetically modified strains. However, mice are quite small compared to the useful spatial resolution of animal PET scanners, and there is a lot of interest in improving the spatial resolution to visualize and quantify the tracer concentration in various organs in mice. Making the detectors ½ of their present size increases the complexity and cost of an animal PET scanner. The proposed modification could achieve comparable performance improvements much more cost effectively . It is anticipated that many research centers and pharmaceutical companies would be willing to purchase more than one scanner in order to allow simultaneous experiments with one production of a radio-labeled tracer.

The preferred embodiment of the inventive method will be described with reference to improving PET images in a system using a wobbling bed rather than a wobbling detector array. It will be recognized that not all tomographic imaging modalities employ a detector ring, and the principle of recovering the projection matrix using detector motion information is not restricted to the ring geometry; however, the circular ring provides a useful framework for considering object's motion in tomography.

The purpose of object motion in the inventive method is to aid the signal recovery process by introducing additional measurement points in the radial (lateral) and angular directions. The inventive method makes use of the fact that each event corresponding to the detection of a pair of gamma rays assigned to a unique pair of crystals, can be assigned to the appropriate sinogram bin according to the relative position of the object with respect to the stationary array of detectors.

Next, the recovered projection profile elements are used to form the rows of an array known in the art as a projection matrix or sinogram. Having mitigated the effect of the spatial response functions, the image may then be reconstructed from the assembled projection matrix using a known reconstruction technique such as, for example, filtered backprojection.

It will be recognized that although the aforedescribed method moves the detectors to obtain additional signal information, the same result will occur if the object is moved and the detectors remain stationary. Therefore the inventive method requires relative motion i.e., motion between an object from which a desired measurement is sought relative to the corresponding detection mechanism. The inventive method uses motion to retrieve additional signal information normally ignored in conventional systems using interpolation techniques.

It will be noted that the above embodiments may also be useful in a variety of other tomographic systems including x-ray computed tomography (CT) systems. Furthermore, the inventive method may find particular use in non-medical activities such as non-destructive testing.

Specific embodiments of novel methods for improving signal recovery in tomographic systems have been described for the purposes of illustrating the manner in which the invention may be used and made. It should be understood that the implementation of other variations and modifications of the invention in its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A PET scanner for imaging small animals, or biological samples, comprising: stationery, circular arrays of gamma-ray sensitive detectors, forming a cylindrical detector, into which the object to be scanned is placed on a support which executes an eccentric movement during the scan, such that the radius of the movement is of the order of the detector width.

2. A scanner as described in claim 1, in which a record of the addresses of each pair of crystals which detects simultaneous gamma rays during the scan is saved in the event-by-event list into which timestamps and reports of the position of the moving support are introduced at appropriate times during the scan.

3. A scanner as described in claim 2 wherein the location of the support at the time of each detection of each pair of simultaneous gamma rays may be determined by interpolation between the respective timestamps and support position reports.

4. A scanner as described in claim 3 wherein the position information may be used to increase the spatial sampling frequency of the moving object by incorporating its position, at the time of each detection into a mathematical algorithm used to reconstruct the image of the object from the recorded events.

5. A scanner as described in claim 4 which enables higher spatial frequencies to be extracted from the detected events that would be possible if the object remained stationary during the scan.

6. A PET scanner for an object comprising:
a plurality of stationary detectors; and
a support for the object which moves continuously in a predetermined way while the detectors obtain data from the object, the detectors disposed about the support.

7. A scanner as described in claim 6 including a signal processor connected to the detectors.

8. A scanner as described in claim 7 wherein the detectors are part of a gantry which receives the support.

9. A scanner as described in claim 8 wherein the support includes a bed upon which the object is placed.

10. A scanner as described in claim 9 wherein the support includes a stand for the bed.

11. A scanner as described in claim 10 wherein the support includes eccentric bearings through which the bed is coupled to the stand.

12. A scanner as described in claim 11 wherein the support includes a motor which moves the bed.

13. A scanner as described in claim 12 wherein the support includes a shaft with disks attached to the shaft, the motor drives the shaft.

14. A scanner as described in claim 13 wherein the support includes a toothed belt connected to the motor and the shaft through which the motor drives the shaft.

15. A scanner as described in claim 14 wherein the structure includes an axle attached to the disks and the bed.

16. A scanner as described in claim 15 wherein the axle is offset from the shaft by a distance R, which defines a wobble circle radius that the bed is constrained to move in by the motor.

17. A scanner as described in claim 16 wherein the detectors obtain data in list mode.

18. A PET scanner for an object comprising:
means for obtaining data from the objects; and
means for supporting the object which moves continuously in a predetermined way, the obtaining means disposed about the support means.

19. A method for scanning an object comprising the steps of:
moving a support with the object continuously in a predetermined way; and
obtaining data from the object with stationary detectors disposed about the support as the support is moved continuously.

20. A method as described in claim 20 wherein the moving step includes the step of moving the support with the object in an eccentric movement during the scan, such that the radius of the movement is of the order of the detector width.
